(19) United States
(12) Patent Application Publication
(10) Pub. No.: US 2008/0246294 A1
(43) Pub. Date: Oct. 9, 2008

(54) SIDE-VIEW MIRROR WITH DOOR-OPEN LIGHT

(76) Inventor: FU MING HSIAO, Pa Te City (TW)

Correspondence Address: LEONG C LEI, PMB # 1008, 1867 YGNACIO VALLEY ROAD, WALNUT CREEK, CA, 94598, US

(21) Appl. No.: 12/053,625

(22) Filed: Mar. 24, 2008

(30) Foreign Application Priority Data
Apr. 4, 2007 (TW) 096205454

(51) Int. Cl. B60R 1/06

(52) U.S. Cl. 296/1.11

(57) ABSTRACT

The side-view mirror at the driver side or the passenger side of a motor vehicle has a chamber on a top side of the side-view mirror's housing. The chamber has an opening facing a back side of the motor vehicle, which is sealed by a transparent screen. A circuit element having a light-producing element is installed in the chamber. The light-producing element protrudes a through hole of a reflection member. The circuit element is series-connected to a control circuit for flashing the light-producing element and a door-open switch. When a door on the same side as the side-view mirror is opened or closed, the door-open switch is closed or opened accordingly, which in turn allows electricity to be delivered to or disrupted from the light-producing element and the control circuit.

### (a) TECHNICAL FIELD OF THE INVENTION

The present invention generally relates to side-view mirrors of motor vehicles, and more particularly to a side view mirror incorporating a lighting element that is automatically flashed when the motor vehicle's door is opened.

### (b) DESCRIPTION OF THE PRIOR ART

A common traffic accident is that, when a driver or a passenger of a motor vehicle suddenly opens the door, a passing-by passenger, motorcycle or bicycle rider, or another motor vehicle could bump directly into the opened door. This would usually causes severe property damage or body injury, and sometimes even the lost of human life.

### SUMMARY OF THE INVENTION

Accordingly, a novel side-view mirror is provided herein that is capable of alerting people behind the motor vehicle that a door at the same side as the side-view mirror is just opened.

A side-view mirror of the present invention, which could be one on the driver side or the passenger side of a motor vehicle, has a chamber on a top side of the side-view mirror's housing. The chamber has an opening facing a back side of the motor vehicle, which is sealed by a transparent screen. A circuit element having a light-producing element installed is positioned inside the chamber. The light-producing element protrudes a through hole of a reflection member which reflects and spreads the light generated by the light-producing element. The circuit element is series-connected to a control circuit and a door-open switch. When a door on the same side as the side-view mirror is opened or closed, the door-open switch is closed or opened accordingly, which in turn allows electricity to be delivered to or disrupted from the light-producing element and the control circuit. The control circuit, driven by the electricity, then flashes the light-producing element so as to alert people behind the motor vehicle to watch out for the opened door.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective-view diagram showing the major components of a side-view mirror according an embodiment of the present invention.

FIG. 2 is a cross-section-view diagram showing the side-view mirror of FIG. 1.

FIG. 3 is a perspective-view diagram showing the side-view mirror of FIG. 1 after its assembly.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

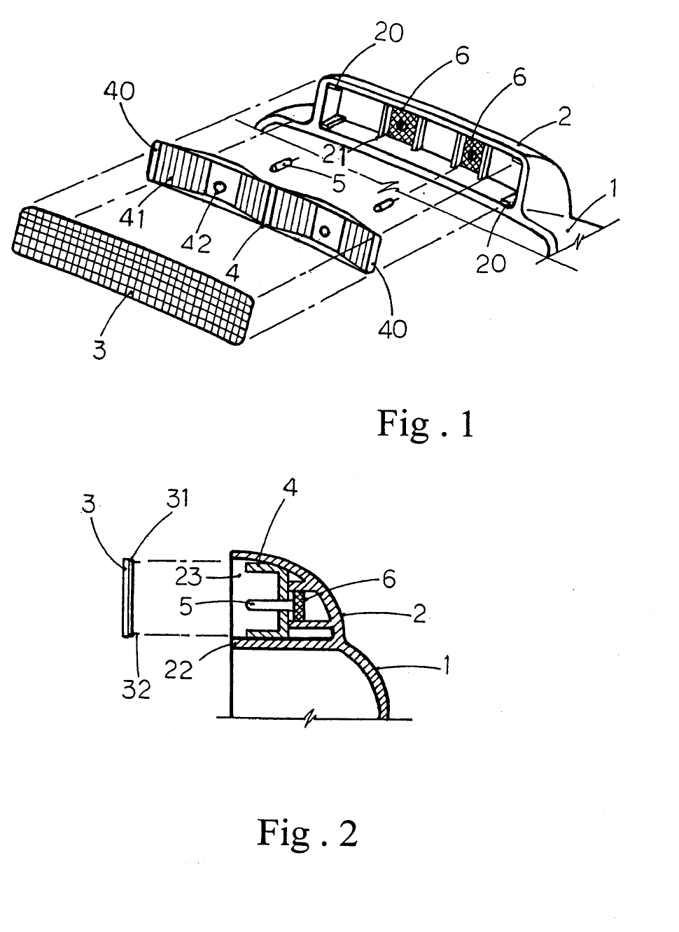

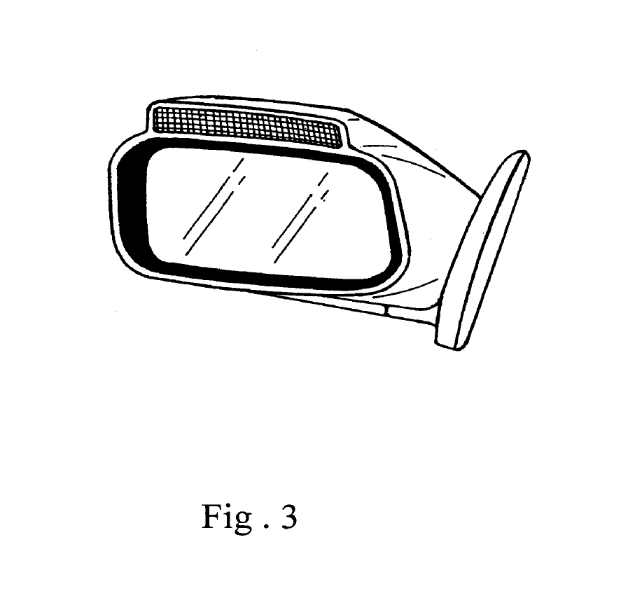

As shown in FIGS. 1 to 3, a housing 1 of a driver-side or passenger-side side-view mirror of a motor vehicle (not shown) according to an embodiment of the present invention has a chamber 2 extended upward from a top side of the housing 1. The chamber 2 is open towards a back side of the motor vehicle. The side-view mirror further contains a reflection member 4, a number of light-producing elements 5 (e.g., light emitting diodes), and a number of circuit elements 6, all sealed inside the chamber 2 by a transparent screen 3.

The chamber 2 is separated from the rest of the housing 1 by a lateral partition 22 so that the chamber 2 forms an independent and watertight space. The chamber 2 has a backward-facing opening 23 and a number of joining elements 20 along an inner circumference of the chamber 2 adjacent to the opening 23. The chamber 2 further has a least a pair of sockets 21 inside that faces backward.

The screen 3 has a waterproofing ring 31 along a front circumference of the screen 3 and a number of buckle elements 32, also along the front circumference of the screen 3, for locking onto the joining elements 20 so that the screen 3 is securely and tightly held at the opening 23 of the chamber 2. The waterproofing ring 31 prevents rain, water, and dusts to permeate or enter into the chamber 2.

The reflection member 4 has a number of sections (not numbered), each corresponding to a socket 21 of the chamber 2. Inside each section, there is a through hole 42 through which a light-producing element 5 penetrates. Along a back side of each section, a reflective material is coated around the through hole 42 so as to enhance the brightness of the light-producing element 5. In addition, a number of reflection strips 41 are provided besides the through hole 42 and the reflection strips 41 are tilted outward (from the chamber 2) so as to spread the light from the light-producing element 5 to form wider and larger coverage. Similarly, a number of buckle elements 40 are provided for locking onto the joining elements 20 so that the reflection member 4 is reliably held inside the chamber 2.

A light-producing element 5 is installed on a circuit element 6, and each circuit element 6 is installed inside a socket 21 so that the light-producing element 5 faces the opening 23 of the chamber 2. After the reflection member 4 is installed, each light-producing element 5 is threaded through a through hole 42 of the reflection member 4. The circuit elements 6 are series-connected together and to a control circuit and a door-open switch (both not shown) of the motor vehicle. The control circuit, when driven by electricity, is to flash the light-producing element 5 so as to produce visual alarm to people behind the motor vehicle. The door-open switch is to control the delivery or disruption of electricity to the light-producing elements 5, circuit elements 6, and the control circuit, in accordance with the close or open of a door along the same side of the motor vehicle as the side-view mirror.

As such, when a door at the driver or passenger side of the motor vehicle is closed, the door-open switch at that side is opened so that no electricity is delivered to the control circuit and the light-producing elements 5. On the other hand, when a door at the driver or passenger side is just opened, the door-open switch at that side is closed to allow electricity to be delivered to the control circuit and the light-producing elements 5. The light-producing elements 5 are thereby flashed by the control circuit to alert people behind to watch out for the opened door.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A side-view mirror at a side of a motor vehicle, comprising:
a housing having a chamber extended from a side of said housing, said chamber having an opening towards a back side of said motor vehicle;
a transparent screen sealing said opening of said chamber;
a light-producing element;
a circuit element having said light-producing element installed, said circuit element positioned inside said chamber so that said light-producing element faces said opening of said chamber, said circuit element series-connected to a control circuit and a door-open switch of said motor vehicle; and
a reflection member inside said chamber between said light-producing element and said screen;
wherein, when a door at said side of said motor vehicle is closed, said door-open switch is opened so that no electricity is delivered to said control circuit and said light-producing element; when a door at said side of said motor vehicle is opened, said door-open switch is closed to allow electricity to be delivered to said control circuit and said light-producing element; and said control circuit, when driven by electricity, flashes said light-producing element to alert people behind said motor vehicle.

2. The side-view mirror according to claim 1, wherein said chamber has a socket for positioning said circuit element.

3. The side-view mirror according to claim 1, wherein said chamber has a plurality of joining elements along an inner circumference of said chamber for locking said reflection member and said screen.

4. The side-view mirror according to claim 3, wherein said screen has a plurality of buckle elements along a front circumference of said screen for locking into said joining elements, respectively.

5. The side-view mirror according to claim 3, wherein said reflection member has a plurality of buckle elements along a front circumference of said reflection member for locking into said joining elements, respectively.

6. The side-view mirror according to claim 1, wherein said chamber is separated from said housing by a partition.

7. The side-view mirror according to claim 1, wherein said screen has a ring along a front circumference of said screen for waterproofing said chamber.

8. The side-view mirror according to claim 1, wherein said reflection member has a through hole allowing said light-producing element to penetrate through.

9. The side-view mirror according to claim 1, wherein said reflection member has a plurality of reflection strips on a back side of said reflection member besides said light-producing element; and said reflection strips are tilted outward so as to spread the light from said light-producing element to form wider and larger coverage.

10. The side-view mirror according to claim 1, wherein said reflection member has a layer of reflective material coated on a back side of said reflection member.
